(19) United States
(12) Patent Application Publication
(10) Pub. No.: US 2014/0147594 A1
(43) Pub. Date: May 29, 2014

(54) Magnesium Fluoride and Magnesium Oxyfluoride based Anti-Reflection Coatings via Chemical Solution Deposition Processes

(71) Applicant: INTERMOLECULAR INC., San Jose, CA (US)

(72) Inventors: Scott Jewhurst, Redwood City, CA (US); Nikhil Kalyankar, Mountain View, CA (US)

(73) Assignee: Intermolecular Inc., San Jose, CA (US)

(21) Appl. No.: 13/686,044

(22) Filed: Nov. 27, 2012

(51) Int. Cl. B05D 5/06

(52) U.S. Cl. CPC B05D 5/061
USPC 427/373

(57) ABSTRACT

Chemical solution deposition process can be used to deposit porous coatings containing magnesium fluoride and/or magnesium oxyfluoride. The chemical solution deposition process can utilize a solution containing a magnesium precursor, a fluorine precursor, together with a surfactant porogen. The surfactant porogen can improve the wettability of the coated layers, together with increase the control of the porosity level and morphology of the coated layers.

### FIELD OF THE INVENTION

Embodiments of the invention relate generally to methods and apparatuses for forming antireflection layers on substrates.

### BACKGROUND OF THE INVENTION

Coatings that provide low reflectivity or a high percent transmission over a broad wavelength range of light are desirable in many applications including semiconductor device manufacturing, solar cell manufacturing, glass manufacturing, and energy cell manufacturing. The refractive index of a material is a measure of the speed of light in the material which is generally expressed as a ratio of the speed of light in vacuum relative to that in the material. Single layer low reflectivity coatings generally have a refractive index (n) in between air (n=1) and glass (n˜1.5).

An anti-reflective (AR) coating is a type of low reflectivity coating applied to the surface of a transparent article to reduce reflectivity of visible light from the article and enhance the transmission of such light into or through the article. One method for decreasing the refractive index and enhancing the transmission of light through an AR coating is to increase the porosity of the anti-reflective coating. Porosity is a measure of the void spaces in a material. Although such anti-reflective coatings have been generally effective in providing reduced reflectivity over the visible spectrum, the coatings have suffered from deficiencies when used in certain applications. For example, porous metal oxide AR coatings which are used in solar applications are highly susceptible to moisture absorption due to their affinity for water (hydrophilicity). Moisture absorption may lead to an increase in the refractive index of the AR coating and corresponding reduction in light transmission.

Magnesium fluoride thin films can be deposited by evaporation or sputtering, resulting in columnar and dense films, which can be unsuitable for anti-reflective coatings. Sol-gel methods can produce magnesium fluoride thin films using colloidal crystalline MgF₂ nanoparticles, which can be sintered at high temperatures. Magnesium fluoride thin films can also be formed by exposing magnesium oxide to fluorine-containing vapors. These processes to form magnesium fluoride thin films can provide minimum control over the porosity level of the coated layers, resulting in limited ranges of index of refraction.

Thus, there is a need for AR coatings which exhibit increased transmission, reliability and durability.

### SUMMARY OF THE DISCLOSURE

In some embodiments, methods, and coated articles formed by the methods, to form anti-reflective coatings having magnesium fluoride (MgF₂) or magnesium oxyfluoride (MgOF) are provided. The anti-reflective coatings can have a controllable porosity content, which can be used to adjust the reflective index of the coatings, for example, to optimize the anti-reflective properties.

The methods can include a chemical solution deposition process, which utilizes a solution containing magnesium and fluorine. The solution can include a metal organic precursor of magnesium together with a fluorine-containing precursor. For example, the magnesium organic precursors can include magnesium alkoxides, magnesium alkylcarbonates, magnesium carbonate and hydrogen carbonate (bicarbonate), magnesium carboxylates, and magnesium beta-diketonates. The fluorine-containing precursors can include HF, fluorides, fluorinated alcohols, fluorinated carboxylic acids, fluorinated amines, and other fluorocarbon gases. The solution can include a metal organic precursor containing magnesium and fluorine. The magnesium and fluorine organic precursors can include magnesium fluoroalkoxides, and magnesium fluorocarbons.

In some embodiments, the chemical solution deposition process can include forming a coating of a solution containing magnesium and fluorine, followed by a thermal processing of the coating to form magnesium fluoride of magnesium oxyfluoride nanoparticles. In some embodiments, the chemical solution deposition process can include forming a coating of a solution containing magnesium, followed by a thermal processing of the coating in a fluorine containing gaseous ambient to form magnesium fluoride of magnesium oxyfluoride nanoparticles.

The level of porosity, e.g., solid or hollow nanoparticles of magnesium fluoride of magnesium oxyfluoride, can be controlled through the choice and concentration of precursors, together with process conditions of the chemical solution deposition process. In addition, pore-templating additives, such as micellar surfactants or polymers, can be added to further control the porosity level and morphology of the coated layers.

In some embodiments, anti-reflective coatings including nanocomposite coatings of silica, fluorine-doped silica, magnesium fluoride or magnesium oxyfluorides (MgOF) are provided. MgF₂ and MgOF coatings can be compatible with silica and fluorine-doped silica, allowing layers of SiO₂, fluorine doped SiO₂ (F:SiO₂)F:SiO2, MgF₂, MgOF. Graded porosity or RI coatings may be formed of layered MgF₂ nanoparticle films with different porosity levels or with MgF₂ nanoparticle films layered on a higher index film (SiO₂, LaF₃, etc.), with each layer being deposited and sintered separately. For example, graded porosity coatings using MgF₂ and/or MgOF, with or without SiO₂ and/or F:SiO₂, can be formed with lower index of refraction, as compared to coatings using all-silica particles.

### BRIEF DESCRIPTION OF THE DRAWINGS

To facilitate understanding, identical reference numerals have been used, where possible, to designate identical elements that are common to the figures. The drawings are not to scale and the relative dimensions of various elements in the drawings are depicted schematically and not necessarily to scale.

The techniques of the current invention can readily be understood by considering the following detailed description in conjunction with the accompanying drawings, in which:

FIG. 1 illustrates a porous coating according to some embodiments.

FIG. 2 illustrates a flow chart showing the principle steps of a chemical solution deposition process according to some embodiments.

FIG. 3 illustrates a flowchart to process a coating according to some embodiments.

FIG. 4 illustrates a flowchart to process a coating according to some embodiments.

FIG. 5 illustrates a flowchart to process a coating according to some embodiments.

### DETAILED DESCRIPTION OF THE PREFERRED EMBODIMENTS

A detailed description of one or more embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to the embodiments has not been described in detail to avoid unnecessarily obscuring the description.

In some embodiments, provided are methods, and coated articles fabricated from the methods, for forming porous coatings utilizing magnesium fluoride (MgF₂) or magnesium oxyfluoride (MgOF, MgOₓF₂₋ₓ) particles. The magnesium fluoride or magnesium oxyfluorides porous coatings can have a controllable porosity content, which can be used to adjust the refractive index of the coatings to optimize the anti-reflective properties. Magnesium fluorides and magnesium oxyfluorides have lower refractive index (n=1.38), which can allow the fabrication of less porous anti-reflective coatings than silica (SiO₂) (which has refractive index of n=1.46 @ 587.6 nm), while providing a more robust coating due to the greater skeletal density and excellent mechanical and chemical properties of magnesium fluoride and magnesium oxyfluorides. Further, lower index of refraction films may be practically achieved (e.g., n<1.10) as compared to silica anti-reflective porous coatings (e.g., n>1.15).

The porous layer using magnesium fluorides and magnesium oxyfluorides can offer significant advantages, for example, as compared to silica or titania porous film in anti-reflective coating. For example, magnesium fluorides and magnesium oxyfluorides do not react with water, unlike silica, which provides it with excellent long term environmental stability. Magnesium fluorides can be sparingly soluble in water (0.002 g/L), but is pH and salt insensitive compared to silica. Magnesium fluorides can be attacked by HNO₃. Magnesium fluorides and magnesium oxyfluorides may be rendered very hydrophobic, preventing adsorption of water on porous films that could lead to environmental degradation or increase in refractive index of the film. Mechanical properties and chemical resistance of magnesium fluoride can be equal to or better than silica in most cases. For example, magnesium fluorides can exhibit good mechanical durability due to its high hardness (H_{c}=415 Knoop) and strength (Young's Modulus, E_{c}=138 GPa) as compared to that of fused silica glass (H_{c}=500 Knoop and E_{c}=73.1 GPa).

Magnesium fluorides and magnesium oxyfluorides can possess highly to fully fluorinated surfaces, resulting in extremely low moisture affinity even for the magnesium oxyfluoride coatings. Also, magnesium fluorides and magnesium oxyfluorides coatings can be compatible with silica and fluorine-doped silica, allowing silica-magnesium fluoride multilayer laminates or silica-magnesium fluoride nanocomposite coatings to be fabricated.

Magnesium fluorides and magnesium oxyfluorides can be easily modified to become very hydrophobic and oleophobic without using UV-sensitive fluoroalkylsilanes. Magnesium fluoride and magnesium oxyfluoride coatings may be produced using processing temperatures from 100° C. to 1200° C., providing a broad process window and substrate compatibility (e.g., plastics, glasses, etc.). Superior transparency in the UV and IR (e.g., wavelength between 0.12 and 8.0 μm) as compared to that of SiO₂ (e.g., wavelength between 0.25 and 2.3 μm) allows for improved irradiance to photovoltaic absorbers across the solar spectrum and superior UV stability to silica.

The composition of magnesium oxyfluoride can be controlled through selection of precursors, precursor concentrations, and processing conditions. For example, the ratio of oxygen to fluorine in magnesium oxyfluoride can range from 0, e.g., magnesium fluoride (MgF₂), to 1, e.g., magnesium oxygen fluoride (MgOF) or higher. The coating can be processed at a wide range of temperatures, providing compatibility of anti-reflective coating deposition onto different substrates, such as polymeric, glass or other substrates. Further, the anti-reflective coatings can be applied either before or after the tempering step during the production of glasses having anti-reflective coatings.

Porosity level and morphology of the magnesium fluoride and magnesium oxyfluoride coatings can be controlled with the use of additives, such as surfactants or porogens. Surfactants can be added in the coatings or coating processes to improve wetting and conformality of the coatings. Porogens, such as pore templating additives, can be added to improve porosity control, such as acting as a porosity modifier. Surfactants, molecularly dispersed or micellar, may also act as porogens.

Through selection of precursors, additives such as surfactants, porogens, reagent concentrations, and processing conditions, the porosity range and index of refraction range of the anti-reflective coatings can be between 1.09 and 1.38.

The window of the fabrication process of magnesium fluorides and magnesium oxyfluorides can be broad, with great selections of precursors, concentrations of reactants, porogens, and processing conditions to determine level of porosity in final film as well as the film structure (solid vs. hollow nanoparticles). For example, pore-templating additives (surfactants, polymers) may be added to provide additional porosity level and morphology control, as well as improving wetting and conformality of the coatings. Further, graded porosity and graded index of refraction coatings using magnesium fluoride and magnesium oxyfluoride with or without silica can provide lower reflectivity than all-silica anti-reflective coating, e.g., due to the lower achievable index of refraction of magnesium fluoride and magnesium oxyfluoride porous coatings.

Magnesium fluoride and magnesium oxyfluoride coatings can be compatible with silica and fluorine-doped silica, thus nanocomposite or nanolaminate coatings of silica, fluorine-doped silica, magnesium fluoride or magnesium oxyfluoride can be used. In addition, graded porosity or refractive index coatings may be formed of layered MgF₂ nanoparticle films with different porosity levels or with MgF₂ nanoparticle films layered on a higher index film (SiO₂, LaF₃, etc.), with each layer being deposited and sintered separately. For example, graded porosity coatings using MgF₂ and/or MgOF, with or without SiO₂ and/or F:SiO2, can be formed with lower index of refraction, as compared to coatings using all-silica particles.

The term “porosity” as used herein is a measure of the void spaces in a material, and may be expressed as a fraction, the “pore fraction” of the volume of voids over the total volume, between 0 and 1, or as a percentage between 0 to 100%.

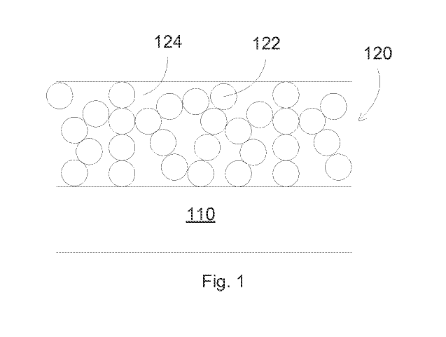

FIG. 1 illustrates a porous coating according to some embodiments. A porous layer 120 is disposed on a substrate 110. The porous layer 120 can include particles 122 disposed in a network 124. The particles can be magnesium fluoride (MgF₂) particles, or magnesium oxyfluoride (MgOF, MgOₓF_{y}) particles. The particles are shown as spherical particles, but can be any shapes and sizes, such as elliptical particles or polyhedral-shaped particles. The network can include a binder to connect the particles 122.

In some embodiments, the porous coating can be formed by a wet chemical film deposition process, such as chemical solution deposition process, using one or more precursors containing magnesium and fluorine to produce anti-reflective coatings with a low refractive index (e.g., lower than glass). The porous coatings can include magnesium fluoride or magnesium oxyfluoride based particles. The deposition process can also include surfactants and/or porogens to improve wetting and coating conformality, as well as porosity modification.

Chemical solution deposition refers to solution-based processes for the synthesis of thin films. An advantage of the chemical solution deposition process is its simplicity and low cost. The chemicals used in the chemical solution deposition can have a surfactant additive to improve the wetting properties, for example, to improve the coverage of the substrate and for better conformality coatings.

In a chemical solution deposition process, precursor molecules are deposited on a substrate to form a coating. Solvent can be used in the process, as a carrier medium to deposit the precursor molecules on the substrate surface. For example, the precursor molecules can contain magnesium and fluorine ligands, together with additives, and can be dissolved or mixed in a solvent. The liquid coating can be subjected to an anneal process to remove the solvent and volatile materials, together with activating a reaction or precipitation of the precursor molecules, e.g., magnesium and fluorine, to form magnesium fluoride or magnesium oxyfluoride.

In a chemical solution deposition process, the solution containing the precursor molecules can be deposited on the substrate by dipping, spraying or spin coating. The wet film will solidify (gel) upon evaporation of excess solvent, and can then be annealed to form the final (dry) film. For thick film deposition, a sequence of deposition and heat treatment followed by a final annealing step can be used.

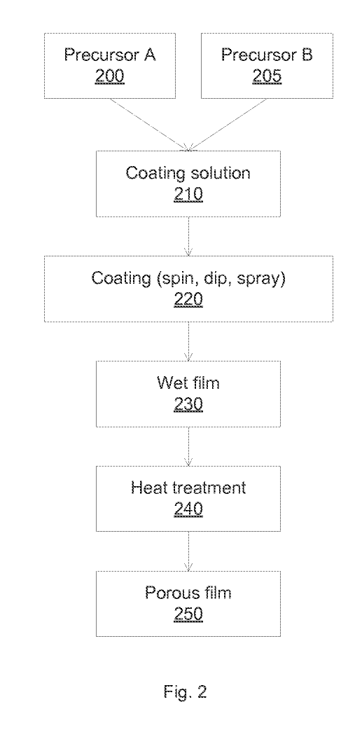

FIG. 2 illustrates a flow chart showing the principle steps of a chemical solution deposition process according to some embodiments. Precursor A (200) and a precursor B (205) can be mixed, for example, in a solvent, to form a coating solution 210. The precursors can be in liquid or solid form, or can be dissolved in a solution. Other additives can be added to the solution, such as a surfactant for improved wettability and porosity modification, and/or a porogen for porosity modification. The precursors can react in the solution or can remain in liquid form in the solution. For example, a precursor containing magnesium and a precursor containing fluorine can be mixed in a solvent to form a liquid coating solution.

The liquid coating solution can be coated 220 on a substrate surface to form a wet film 230. The substrates can include glass, ceramics, or plastics. The substrate may be a transparent substrate. The substrate could be optically flat, textured, or patterned. The substrate may be flat, curved or any other shape as necessary for the application under consideration. The glass substrates can include high transmission low iron glass, borosilicate glass (BSG), soda lime glass, aluminosilicate glasses, quartz glass or other silicate glasses. The liquid solution may be coated on the substrate using, for example, dip coating, spin coating, curtain coating, roll coating, capillary coating, or a spray coating process. Other application methods known to those skilled in the art may also be used. The substrate may be coated on a single side or on multiple sides.

The substrate, and the wet film 230, can be subjected to a treatment process to evaporate the solvent and any volatile material, resulting in a porous film 250 on the substrate. The porous film can be amorphous or crystalline. The treatment process can include a heat treatment process, accelerating the reaction of the precursors to form solid particles, while also modifying the porosity. For example, magnesium precursor and fluorine precursor can react to form magnesium fluoride particles. If the solvent or the precursor solution contains oxygen, the reaction can also form magnesium oxyfluoride.

In some embodiments, the heat treatment process can include a two step curing process, for example, a first treatment step to form the particles, e.g., magnesium fluoride particles, and enhance the bonding between the particles, and a second treatment to modify the porous layer, e.g., remove organic content and generate void space in the coated layer. The wet film can be dried to form a gel coating before heat treated to form a solid porous material.

During the drying, the solvent is evaporated and further bonds between the components, or precursor molecules, may be formed. The drying may be performed by exposing the coating on the substrate to the atmosphere at room temperature. The wet coatings (and/or the substrates) may alternatively be exposed to an elevated temperature near or above the boiling point of the solvent. The drying of the coatings may not require elevated temperatures, but may vary depending on the formulation of the coating solution. In some embodiments, the drying temperature may be in the range of approximately 25 degrees Celsius to approximately 200 degrees Celsius. In some embodiments, the drying temperature may be in the range of approximately 50 degrees Celsius to approximately 60 degrees Celsius. The drying process may be performed for a time period of between about 1 minute and 10 minutes, for example, about 6 minutes. Drying temperature and time are dependent on the boiling point of the solvent used in the coating solution.

The wet coating can be fully cured, e.g., heat treated to a final temperature, to form a porous coating. The temperature and time of the heat treatment may be selected based on the chemical composition of the coating solution, depending on what temperatures may be required to form cross-linking between the components throughout the coating. In some embodiments, the temperature may be 100 degrees Celsius or greater. In some embodiments, the temperature may be between 100 and 300 degrees Celsius. In some embodiments, the temperature may be between 300 and 500 degrees Celsius. In some embodiments, the temperature may be in the range of 500 degrees Celsius to 1,000 degrees Celsius. In some embodiments, the temperature may be 600 degrees Celsius or greater. In some embodiments, the temperature may be between 625 degrees Celsius and 650 degrees Celsius. The heat treatment process may be performed for a time period of between about 3 minutes and 1 hour, for example, about 6 minutes. The single porous coating may have a thickness between about 5 nanometers and about 1,000 nanometers.

In some embodiments, the porous coating can be formed by a heat treatment process where a chemical compound in the coating solution can burn off upon combustion to form a void space or pore of a desired size and shape. The size and interconnectivity of the pores may be controlled, for example, through the sol-formulation, polarity of the molecule and solvent, and other physiochemical properties of the gel phase, in addition to the parameters of the heat treatment process.

In some embodiments, the coating solution can include one or more film forming precursors which form magnesium fluoride or magnesium oxyfluoride. The film forming precursors can include a magnesium containing precursor and a fluorine containing precursor. The coating solution may be stirred at room temperature or at an elevated temperature (e.g., 50-60 degrees Celsius) until the coating solution is substantially in equilibrium (e.g., for a period of 24 hours). The coating solution may then be cooled and additional solvents or additives added to improve the properties of the coating solution.

The formation of magnesium fluoride and/or magnesium oxyfluoride may be selected to occur during thermal processing of the wet coating or in solution as small (e.g., less than 20 nm) nanoparticles, eliminating or reducing the need for sintering to produce a coating with strong adhesion and cohesion. In general, the conversion of Mg—O bonding in the magnesium precursor to Mg—F bonding is thermodynamically favored under process conditions, but reaction efficiency can be chemistry and process dependent. For example, low temperature (RT-200° C.) and solution formation of MgF₂ and MgOF through use of magnesium fluoroalkoxide and fluorocarboxylate precursors, or through the use of HF, NH₄HF₂, or C(NH₂)₃F with other magnesium precursors.

In some embodiments, the magnesium containing precursors can include magnesium alkoxides (e.g., magnesium methoxide, magnesium ethoxide, magnesium methoxyethoxide, etc.), magnesium alkylcarbonates (e.g., magnesium methyl carbonate, magnesium ethyl carbonate, etc.), magnesium carbonate and magnesium hydrogen carbonate (bicarbonate), magnesium carboxylates (e.g., magnesium formate, magnesium acetate, magnesium citrate, magnesium lactate, magnesium acrylate, magnesium ethylhexanoate, etc.).

In some embodiments, the fluorine containing precursors can include HF (gas, non-aqueous and aqueous solutions), fluorides (e.g., NH₄F, NH₄HF₂, C(NH₂)₃F, etc.), fluorinated alcohols (e.g., trifluoromethanol, trifluoroethanol, etc.), fluorinated carboxylic acids (e.g., trifluoroacetic acid, fluoroacetic acid, etc.), fluorinated amines (e.g., perfluoroethanamine, etc.), or gases containing fluorine, such as CF₄, C₂F₆, COF₂. In some embodiments, thermal cracking can be required to dissociate the fluorine from the fluorine precursors.

In some embodiments, the precursors can contain both magnesium and fluorine. For example, fluorine containing magnesium precursors may form magnesium fluoride and/or magnesium oxyfluoride without an additional fluorine precursor, such as magnesium fluoroalkoxides (e.g., magnesium trifluoromethoxide, magnesium trifluoroethoxide, etc.), magnesium fluorocarbons (e.g., magnesium trifluoroacetate, magnesium trifluoropentanedionate, magnesium hexafluoropentandionate, etc.), magnesium beta-diketonates (e.g., magnesium 2,4-pentanedionate, magnesium acetylacetonate, etc.).

The coating solution can further include a solvent system. The solvent system may include a non-polar solvent, a polar aprotic solvent, a polar protic solvent, and combinations thereof. Selection of the solvent system and the self assembling molecular porogen may be used to influence the formation and size of micelles. The solvents include primary alcohols, for example, ethanol, isopropanol, ketones (acetone), parachlorobenzotrifluoride, fluorinated alcohols, etc. The amount of solvent may be from 35 to 99.9 wt. % of the total weight of the sol-gel composition.

In some embodiments, the coating solution can include a surfactant. In some embodiments, the surfactant may be used to improve the properties of the porous coatings. For example, surfactants can be used to improve wettability of the coating solutions, allowing conformal coating of the coating solution on non-flat features. The surfactant can include an organic compound that lowers the surface tension of a liquid and contains both hydrophobic groups and hydrophilic groups. Thus the surfactant contains both a water insoluble component and a water soluble component. In some embodiments, the surfactant may be used as a porogen which forms molecular aggregates (micelles) before or during the gelation of the coating.

In some embodiments, the fluorine containing precursors can include a fluorocarbon surfactants. For example, fluorocarbon surfactants can include fluorocarbon and perfluorocarbon non-ionic or amine/ammonium cationic surfactants (Dupont Zonyl® and Capstone®, 3M Novec®, etc.). fluorocarbon surfactants Process conditions may need to optimize to prevent the formation of undesirable compounds other than magnesium fluoride or magnesium oxyfluoride.

In some embodiments, the coating solution can include a surfactant that can act as a porogen, e.g., a surfactant porogen, or a pore templating additive. For example, amphiphiles surfactant molecules under controlled conditions can form ordered micellar systems, which can have act as a pore template.

The term “micelle” as used herein is an organized aggregate of surfactant molecules dispersed in a liquid. A typical micelle in aqueous solution forms an aggregate with the hydrophilic head regions of the surfactant molecules in contact with the surrounding aqueous solvent, sequestering the hydrophobic tail regions of the surfactant molecules in the micelle center. In non-polar solvents, the arrangement of the hydrophilic head would be towards the interior of the micelle, while the hydrophobic tail would orient towards the solvent. The difficulty filling all the volume of the interior of a bilayer, while accommodating the area per head group leads to the formation of the micelle. Micelles are often approximately spherical in shape. However, other shapes such as ellipsoids, cylinders, and bi-layers are also possible. The shape and size of a micelle is a function of the molecular geometry of its surfactant molecules and solution conditions such as surfactant concentration, temperature, pH, and ionic strength. The shape and size of the micelle will also dictate pore size and shape in the final coating.

The term “porogen” as used herein is any chemical compound capable of forming a composition which evaporates or burns off upon combustion to form a void space or pore. One example is the formation of micelles by surfactant molecules above a critical micelle concentration.

In some embodiments, the coating solution can include an initial surfactant concentration that is less than the critical micelle concentration. Subsequent treatment processes, e.g., drying, can evaporate the solvent, inducing micellization. Subsequent calcination of the coating can remove the surfactant and organics, resulting in a porous thin film composed of pores templated by the organics and surfactants.

In some embodiments, the use of surfactant porogens can allow further porosity level and morphology control over the spontaneously formed porosity from particle packing or precursor decomposition. Additionally, the improvement in wetting allows for improved coverage and conformality of the coatings, allowing the formation of uniform coatings on textured glass substrates.

In some embodiments, methods to form anti-reflective coatings, and coated articles having anti-reflective coatings fabricated by the methods, are provided, including coating a substrate with a coating solution and heating the substrate to form a porous coating. The coating solution can include magnesium and fluorine precursors, together with a surfactant porogen to control the properties of the porous layer, such as the porosity and/or refractive index. The coated articles can include other layers such as a base layer, a seed layer, an infrared reflective layer, a barrier layer and a protective layer.

In some embodiments, the coating solution can include a magnesium containing precursor, a fluorine containing precursor, and a surfactant porogen or a pore templating agent. The magnesium containing precursors can include magnesium alkoxides, magnesium alkylcarbonates, magnesium carbonate and magnesium hydrogen carbonate, magnesium carboxylates, or any combination thereof. Other magnesium containing precursors can be used. The fluorine containing precursors can include HF, fluorides, fluorinated alcohols, fluorinated carboxylic acids, fluorinated amines, or gases containing fluorine. Other fluorine containing precursors can be used. The surfactant porogen can include a fluorosurfactant such as fluorocarbon, perfluorocarbon, or amine/ammonium cationic fluorocarbon surfactants. Other surfactants can be used. The pore templating agent can include porosity forming agents, such as self assembling molecular porogens, or dendrimers and organic nanocrystals, which can evaporated or decomposed before pyrolysis of precursors.

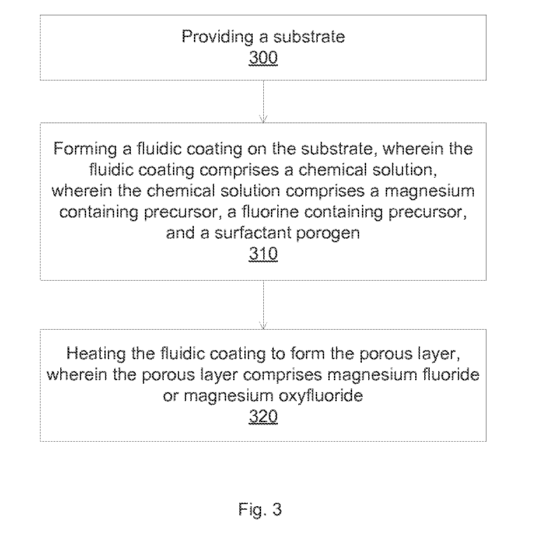

FIG. 3 illustrates a flowchart to process a coating according to some embodiments. In operation 300, a substrate is provided. The substrate can be a transparent substrate, such as a glass substrate or a polymer substrate. Other types of substrates can be used. In operation 310, a fluidic coating is formed on the substrate. The fluidic coating can form a wet layer on the substrate, and can be coated on the substrate using, for example, dip-coating, spin coating, curtain coating, roll coating, capillary coating or a spray coating process. Other application methods known to those skilled in the art may also be used. The substrate may be coated on a single side or on multiple sides of the substrate. The fluidic coating can be provided from a chemical solution, which includes a magnesium containing precursor, a fluorine precursor, and a surfactant or a porogen additive. The magnesium containing precursors can include magnesium alkoxides (e.g., magnesium methoxide, magnesium ethoxide, magnesium methoxyethoxide, etc.), magnesium alkylcarbonates (e.g., magnesium methyl carbonate, magnesium ethyl carbonate, etc.), magnesium carbonate and magnesium hydrogen carbonate (bicarbonate), magnesium carboxylates (e.g., magnesium formate, magnesium acetate, magnesium citrate, magnesium lactate, magnesium acrylate, magnesium ethylhexanoate, etc.), magnesium fluoroalkoxides (e.g., magnesium trifluoromethoxide, magnesium trifluoroethoxide, etc.), magnesium fluorocarbons (e.g., magnesium trifluoroacetate, magnesium trifluoropentanedionate, magnesium hexafluoropentandionate, etc.), magnesium beta-diketonates (e.g., magnesium 2,4-pentanedionate, magnesium acetylacetonate, etc.), or any combination thereof. Other magnesium containing precursors can be used. The fluorine containing precursors can include HF (gas, non-aqueous and aqueous solutions), fluorides (e.g., NH₄F, NH₄HF₂, C(NH₂)₃F, etc.), fluorinated alcohols (e.g., trifluoromethanol, trifluoroethanol, etc.), fluorinated carboxylic acids (e.g., trifluoroacetic acid, fluoroacetic acid, etc.), fluorinated amines (e.g., perfluoroethanamine, etc.), gases containing fluorine, such as CF₄, C₂F₆, COF₂, fluorocarbon surfactants such as fluorocarbon and perfluorocarbon non-ionic or amine/ammonium cationic surfactants (Dupont Zonyl® and Capstone®, 3M Novec®, etc.), magnesium fluoroalkoxides (e.g., magnesium trifluoromethoxide, magnesium trifluoroethoxide, etc.), magnesium fluorocarbons (e.g., magnesium trifluoroacetate, magnesium trifluoropentanedionate, magnesium hexafluoropentandionate, etc.). Other fluorine containing precursors can be used. The surfactant porogen can include a fluorosurfactant such as fluorocarbon, perfluorocarbon, or amine/ammonium cationic fluorocarbon surfactants. Other surfactants can be used. The pore templating agent can include porosity forming agents, which can be evaporated or decomposed before pyrolysis of precursors, self assembling molecular porogens, or dendrimers and organic nanocrystals. The wettability of the fluidic coating can be improved by the surfactant additive.

In operation 320, the gelled coating is treated, for example, by heating, to form a porous layer, for example, by combusting organic matter within the coated layer, and leaving the inorganic components. The porous layer can include magnesium fluoride or magnesium oxyfluoride. The porosity of the porous layer can be controlled by the surfactant or the porogen additive. Other layers can be formed on the substrate. The treatment can include a heated environment, low pressure, and air flow. Other treatments can be used, including exposing the coating to a hydrophobic organophosphonate to impart enhanced hydrophobic properties to the film leading to reduced moisture content, or to a plasma environment containing fluorocarbons to seal the top layer of the pores to make the film more moisture resistant while preserving the optical properties of the film.

In some embodiments, the porous coating layer may have a thickness greater than 50 nm, between 50 nm and 1000 nm, or between 100 nm and 200 nm. The pores of the porous layer may on average be between about 1 nm and about 50 nm. The porous coating may have a pore fraction of between about 0 and about 0.8, or a porosity of between about 0% and about 80% as compared to a solid film formed from the same material.

In some embodiments, the percentage of the surfactant porogen is selected to achieve a porous layer having index of refraction between 1.09 and 1.38,. The temperature of the heating process can be between room temperature and 200 C.

In some embodiments, the coating may be a single coating. In some embodiments, the coating may be formed of multiple coatings on the same substrate. In such embodiments, the coating, gel-formation, and annealing may be repeated to form a multi-layered coating with any number of layers. The multi-layers may form a coating with graded porosity. For example, in some embodiments it may be desirable to have a coating which has a higher porosity adjacent to air and a lower porosity adjacent to the substrate surface. A graded coating may be achieved by modifying various parameters, such as, the type of porosity forming agent, the anneal time, and the anneal temperature.

In some embodiments, methods to form anti-reflective coatings, and coated articles having anti-reflective coatings fabricated by the methods, are provided, including coating a substrate with a coating solution and heating the substrate to form a porous coating. The coating solution can include a magnesium precursor, together with a fluorine surfactant porogen to control the properties of the porous layer, such as the porosity and/or refractive index.

In some embodiments, the coating solution can include a magnesium containing precursor, a fluorine containing surfactant porogen, and/or a pore templating agent. The magnesium containing precursors can include magnesium alkoxides, magnesium alkylcarbonates, magnesium carbonate and magnesium hydrogen carbonate, magnesium carboxylates, or any combination thereof. Other magnesium containing precursors can be used. The fluorine containing precursors can include a fluorosurfactant such as fluorocarbon, perfluorocarbon, Other fluorine containing surfactants can be used.

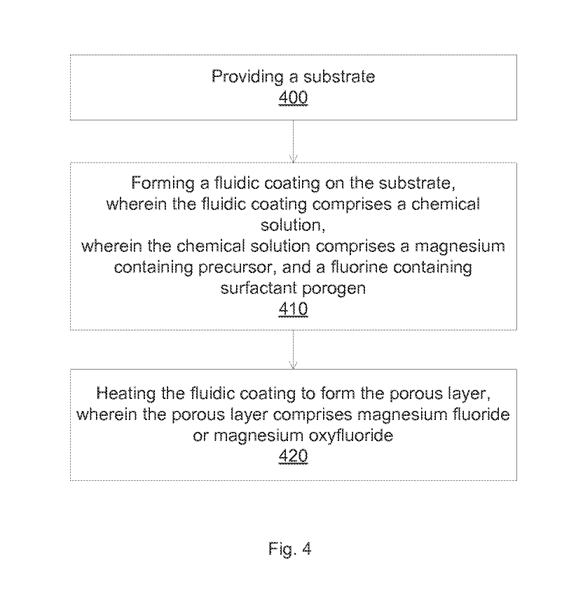

FIG. 4 illustrates a flowchart to process a coating according to some embodiments. In operation 400, a substrate is provided. The substrate can be a transparent substrate, such as a glass substrate or a polymer substrate. Other types of substrates can be used. In operation 410, a fluidic coating is formed on the substrate. The fluidic coating can form a wet layer on the substrate, and can be coated on the substrate using, for example, dip-coating, spin coating, curtain coating, roll coating, capillary coating or a spray coating process. The fluidic coating can be provided from a chemical solution, which includes a magnesium containing precursor, and a fluorine containing surfactant or a porogen additive. The magnesium containing precursors can include magnesium alkoxides (e.g., magnesium methoxide, magnesium ethoxide, magnesium methoxyethoxide, etc.), magnesium alkylcarbonates (e.g., magnesium methyl carbonate, magnesium ethyl carbonate, etc.), magnesium carbonate and magnesium hydrogen carbonate (bicarbonate), magnesium carboxylates (e.g., magnesium formate, magnesium acetate, magnesium citrate, magnesium lactate, magnesium acrylate, magnesium ethylhexanoate, etc.), magnesium fluoroalkoxides (e.g., magnesium trifluoromethoxide, magnesium trifluoroethoxide, etc.), magnesium fluorocarbons (e.g., magnesium trifluoroacetate, magnesium trifluoropentanedionate, magnesium hexafluoropentandionate, etc.), magnesium beta-diketonates (e.g., magnesium 2,4-pentanedionate, magnesium acetylacetonate, etc.), or any combination thereof. Other magnesium containing precursors can be used. The fluorine containing surfactant can include fluorocarbon and perfluorocarbon. Other fluorine containing surfactant precursors that do not contain metals (e.g. Si) can be used.

In operation 420, the gelled coating is treated, for example, by heating, to form a porous layer, for example, by combusting organic matter within the coated layer, and leaving the inorganic components. The porous layer can include magnesium fluoride or magnesium oxyfluoride. The porosity of the porous layer can be controlled by the surfactant or the porogen additive. Other layers can be formed on the substrate. The treatment can include a heated environment, low pressure, and air flow. Other treatments can be used, including exposing the coating to hydrophobic organophosphonate to impart enhanced hydrophobic properties to the film leading to reduced moisture content, or to a plasma environment containing fluorocarbons to seal the top layer of the pores to make the film more moisture resistant while preserving the optical properties of the film.

In some embodiments, methods to form anti-reflective coatings, and coated articles having anti-reflective coatings fabricated by the methods, are provided, including coating a substrate with a coating solution and heating the substrate to form a porous coating. The coating solution can include a precursor containing magnesium and fluorine, together with a surfactant porogen to control the properties of the porous layer, such as the porosity and/or refractive index. The coated articles can include other layers such as a base layer, a seed layer, an infrared reflective layer, a barrier layer and a protective layer.

In some embodiments, the coating solution can include a precursor containing magnesium and fluorine, and a surfactant porogen or a pore templating agent. The magnesium and fluorine containing precursors can include magnesium fluoroalkoxides, and magnesium fluorocarbons. Other magnesium and fluorine containing precursors can be used. The surfactant porogen can include a fluorosurfactant such as fluorocarbon, perfluorocarbon, or amine/ammonium cationic fluorocarbon surfactants. Other surfactants can be used.

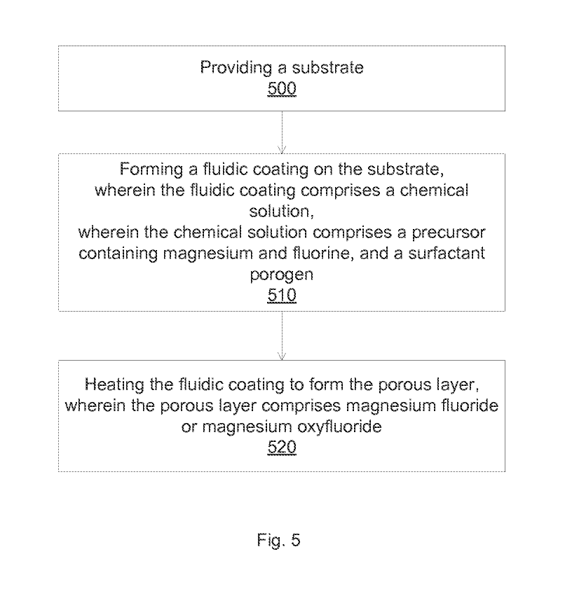

FIG. 5 illustrates a flowchart to process a coating according to some embodiments. In operation 500, a substrate is provided. The substrate can be a transparent substrate, such as a glass substrate or a polymer substrate. Other types of substrates can be used. In operation 510, a fluidic coating is formed on the substrate. The fluidic coating can form a wet layer on the substrate that gels upon evaporation of solvent, and can be coated on the substrate using, for example, dip-coating, spin coating, curtain coating, roll coating, capillary coating or a spray coating process. The fluidic coating can be provided from a chemical solution, which includes a precursor containing magnesium and fluorine, and a surfactant or a porogen additive. The magnesium and fluorine containing precursors can include magnesium fluoroalkoxides (e.g., magnesium trifluoromethoxide, magnesium trifluoroethoxide, etc.), magnesium fluorocarbons (e.g., magnesium trifluoroacetate, magnesium trifluoropentanedionate, magnesium hexafluoropentandionate, etc.), or any combination thereof. Other magnesium and fluorine containing precursors can be used. The surfactant porogen can include a fluorosurfactant such as fluorocarbon, perfluorocarbon, or amine/ammonium cationic fluorocarbon surfactants. Other surfactants can be used. The wettability of the fluidic coating can be improved by the surfactant additive.

In operation 520, the gelled coating treated, for example, by heating, to form a porous layer, for example, by combusting organic matter within the coated layer, and leaving the inorganic components. The porous layer can include magnesium fluoride or magnesium oxyfluoride. The porosity of the porous layer can be controlled by the surfactant or the porogen additive. Other layers can be formed on the substrate. The treatment can include a heated environment, low pressure, and air flow. Other treatment can be used, including exposing to a hydrophobic organophosphonate to impart enhanced hydrophobic properties to the film leading to reduced moisture content, or to a plasma environment containing fluorocarbons to seal the top layer of the pores to make the film more moisture resistant while preserving the optical properties of the film.

In some embodiments, photovoltaic devices can be provided, including a porous anti-reflective coating formed from the active ambient exposure as described herein. The photovoltaic device includes a porous anti-reflective coating disposed on a glass substrate. The incoming or incident light from the sun can be first incident on the anti-reflective coating, passes through and then through the glass substrate before reaching the photovoltaic semiconductor (active film) of the solar cell. The photovoltaic device can also include, but does not require, a reflection enhancement oxide film, and/or a back metallic or otherwise conductive contact and/or reflector. Other types of photovoltaic devices can be used, and the described photovoltaic device is merely illustrative. The anti-reflective coating can reduce reflections of the incident light and permits more light to reach the thin film semiconductor film of the photovoltaic device thereby permitting the device to act more efficiently.

### EXAMPLES

It is believed that the following examples further illustrate the objects and advantages of some of the embodiments. The particular materials and amounts thereof, as well as other conditions and details, recited in these examples should not be used to limit embodiments described herein. Unless stated otherwise all percentages, parts and ratios are by weight. Examples of the invention are numbered while comparative samples, which are not examples of the invention, are designated alphabetically.

Any or all of these examples can have the addition of a surfactant porogen (such as a perfluorocarbon or fluorocarbon) incorporated into the coating solutions. Hydrocarbon surfactants can also be used. Increasing concentration of surfactant porogen will increase the porosity and lower the refractive index. Discontinuous films can be achieved with excessive amount of porogen.

### Example 1

### Porous MgF₂—MgOF Coating from Magnesium Fluoroalkoxides

Magnesium trifluoroethoxide (MgTFE), Mg(OCH₂CF₃)₂, is dissolved in an anhydrous alcohol (ethanol, 1-propanol, 2-propanol, butanol) or trifluoroethanol to form a solution with a concentration of 0.01-1.0M MgTFE. Optionally, water and a fluorine containing catalyst (e.g. HF, NH₄F, NH₄HF₂, CF₃COOH) may be added to concentrations of 0-2.0M (ratio of water or catalyst to Mg≦2). A surfactant porogen is added to the solution. The solution is aged for 0.01 to 24 hrs at 0-40° C., and then applied to a cleaned glass substrate via a solution coating method such as curtain, dip or spin coating. The coating is allowed to dry and gel, and then rapidly heated to 100° C.-800° C. until the coating is converted to MgF₂ or MgOF that has densified to the desired extent. Curing and conversion of the coating may also be induced rapidly by rapid thermal processing methods (IR-UV radiation, laser, microwaves) or exposure to atmospheric pressure plasma discharges. This process may be applied to polymeric substrates if the curing and conversion process does not heat the substrate beyond its softening temperature.

### Example 2

### Porous MgF₂—MgOF Coating from Magnesium Alkoxides

Magnesium methoxide, Mg(OCH₃)₂, is dissolved in an anhydrous alcohol (ethanol, 1-propanol, 2-propanol, butanol) or trifluoroethanol to form a solution with a concentration of 0.01-1.0M Mg. A fluorine containing catalyst (e.g. HF, NH₄F, NH₄HF₂, CF₃COOH) is added to concentrations of 0.02-3.0M (ratio of catalyst to Mg≧2). A surfactant porogen is added to the solution. The solution is aged for 0.01 to 24 hrs at 0-40° C., and then applied to a cleaned glass substrate via a solution coating method such as curtain, dip or spin coating. The coating is allowed to dry and gel, and then rapidly heated to 100° C.-800° C. until the coating converted to MgF₂ or MgOF that has densified to the desired extent. Curing and conversion of the coating may also be induced rapidly by rapid thermal processing methods (IR-UV radiation, laser, microwaves) or exposure to atmospheric pressure plasma discharges. This process may be applied to polymeric substrates if the curing and conversion process does not heat the substrate beyond its softening temperature.

### Example 3

### Porous MgF₂—MgOF Coating from Magnesium Carboxylates

Magnesium Acetate (anhydrous or tetrahydrate), Mg(OAc)₂, is dissolved in a mixture of a primary alcohol, water and trifluoroacetic acid (TFA, CF₃COOH) at 30-70° C. for 1-120 minutes to form a solution with a Mg concentration of 0.01-1.0M, water concentration of 0.01-10M, and a TFA concentration of 0.01-3M. A surfactant porogen is added to the solution. The solution is then applied to a cleaned glass substrate via a solution coating method such as curtain, dip or spin coating. The coating is allowed to dry for 1-10 minutes, and then rapidly heated to 300° C.-800° C. until the coating converted to MgF₂ or MgOF that has densified to the desired extent. Curing and conversion of the coating may also be induced rapidly by rapid thermal processing methods (IR-UV radiation, laser, microwaves) or exposure to atmospheric pressure plasma discharges.

### Example 4

### Porous MgF₂—MgOF Coating from Magnesium—Diketonates

Magnesium 2,4-pentanedionate (anhydrous or dihydrate), Mg(acac)₂, is dissolved in a mixture of a primary alcohol, water and ammonium fluoride (NH₄F) at 30-70° C. for 1-120 minutes to form a solution with a Mg concentration of 0.01-1.0M, water concentration of 0-5M, and a NH₄F concentration of 0.01-3M. A surfactant porogen is added to the solution. The solution is then applied to a cleaned glass substrate via a solution coating method such as curtain, dip or spin coating. The coating is allowed to dry for 1-10 minutes, and then rapidly heated to 300° C.-800° C. until the coating converted to MgF₂ or MgOF that has densified to the desired extent. Curing and conversion of the coating may also be induced rapidly by rapid thermal processing methods (IR-UV radiation, laser, microwaves) or exposure to atmospheric pressure plasma discharges.

### Example 5

### Porous MgF₂—MgOF Coating from Magnesium Fluorocarboxylate and Surfactant

Magnesium trifluoroacetate, Mg(TFAc)₂, is dissolved in a mixture of a primary alcohol, water, and perfluorobutanesulfonic acid (PFBS, HOSO₂C₄F₉) at 20-70° C. for 1-120 minutes to form a solution with a Mg concentration of 0.01-1.0M, water concentration of 0.001-10M, and a PFBS concentration of 0.001-3M. A surfactant porogen is added to the solution. The solution is then applied to a cleaned glass substrate via a solution coating method such as curtain, dip or spin coating. The coating is allowed to dry for 1-10 minutes, and then rapidly heated to 300° C.-800° C. until the coating converted to MgF₂ or MgOF that has densified to the desired extent. Curing and conversion of the coating may also be induced rapidly by rapid thermal processing methods (IR-UV radiation, laser, microwaves) or exposure to atmospheric pressure plasma discharges.

### Example 6

### Porous MgF₂—MgOF—SiO₂ Nanocomposite Coating

Magnesium Acetate (anhydrous or tetrahydrate), Mg(OAc)₂, is dissolved in a mixture of a primary alcohol, SiO₂ nanoparticles (IPA-UP—ST), water and trifluoroacetic acid (TFA, CF₃COOH) at 30-70° C. for 1-120 minutes to form a solution with a Mg concentration of 0.01-1.0M, SiO₂ concentration of 0.005-1.0M, water concentration of 0.01-10M, and a TFA concentration of 0.01-3M. A surfactant porogen is added to the solution. The solution is then applied to a cleaned glass substrate via a solution coating method such as curtain, dip or spin coating. The coating is allowed to dry for 1-10 minutes, and then rapidly heated to 300° C.-800° C. until the Mg(OAc)₂ has converted to MgF₂ or MgOF, forming a porous nanocomposite of SiO₂ nanoparticles and MgF₂—MgOF. Curing and conversion of the coating may also be induced rapidly by rapid thermal processing methods (IR-UV radiation, laser, microwaves) or exposure to atmospheric pressure plasma discharges.

Although the foregoing examples have been described in some detail for purposes of clarity of understanding, the invention is not limited to the details provided. There are many alternative ways of implementing the invention. The disclosed examples are illustrative and not restrictive.

What is claimed is:

1. A method to form a porous layer, the method comprising
providing a substrate;
forming a coating on the substrate,
wherein the coating comprises a chemical solution,
wherein the chemical solution comprises a magnesium containing precursor, a fluorine containing precursor, and a surfactant porogen;
heating the coating to form the porous layer,
wherein the porous layer comprises magnesium fluoride or magnesium oxyfluoride.

2. A method as in claim 1 wherein the magnesium containing precursor comprises at least one of magnesium alkoxides, magnesium alkylcarbonates, magnesium carbonate, magnesium hydrogen carbonate, magnesium carboxylates, magnesium fluoroalkoxides, magnesium fluorocarbons, or magnesium beta-diketonates.

3. A method as in claim 1 wherein the fluorine containing precursor comprises at least one of HF, fluorides, fluorinated alcohols, fluorinated carboxylic acids, fluorinated amines, gases containing fluorine, fluorocarbon, perfluorocarbon, magnesium fluoroalkoxides, or magnesium fluorocarbons.

4. A method as in claim 1 wherein the surfactant porogen comprises at least one of fluorocarbon, perfluorocarbon, amine cationic fluorocarbon surfactants, or ammonium cationic fluorocarbon surfactants.

5. A method as in claim 1 wherein the percentage of the surfactant porogen is selected to achieve a porous layer having index of refraction between 1.09 and 1.38.

6. A method as in claim 1 wherein the temperature of the heating process is between room temperature and 200 C.

7. A method as in claim 1 wherein the porous layer comprises a graded index of refraction.

8. A method as in claim 1 further comprising
repeating the forming and heating.

9. A method to form a porous layer, the method comprising
providing a substrate;
forming a coating on the substrate,
wherein the coating comprises a chemical solution,
wherein the chemical solution comprises a magnesium containing precursor, and a fluorine containing surfactant porogen;
heating the coating to form the porous layer,
wherein the porous layer comprises magnesium fluoride or magnesium oxyfluoride.

10. A method as in claim 9 wherein the magnesium containing precursor comprises at least one of magnesium alkoxides, magnesium alkylcarbonates, magnesium carbonate, magnesium hydrogen carbonate, magnesium carboxylates, magnesium fluoroalkoxides, magnesium fluorocarbons, or magnesium beta-diketonates.

11. A method as in claim 9 wherein the fluorine containing surfactant porogen comprises at least one of fluorocarbon or perfluorocarbon.

12. A method as in claim 9 wherein the percentage of the surfactant porogen is selected to achieve a porous layer having index of refraction between 1.09 and 1.38.

13. A method as in claim 9 wherein the porous layer comprises a graded index of refraction.

14. A method as in claim 9 further comprising repeating the forming and heating.

15. A method to form a porous layer, the method comprising
providing a substrate;
forming a coating on the substrate,
wherein the coating comprises a chemical solution,
wherein the chemical solution comprises a precursor containing magnesium and fluorine, and a surfactant porogen;
heating the coating to form the porous layer,
wherein the porous layer comprises magnesium fluoride or magnesium oxyfluoride.

16. A method as in claim 15 wherein the precursor containing magnesium and fluorine comprises at least one of magnesium fluoroalkoxides, or magnesium fluorocarbons.

17. A method as in claim 15 wherein the surfactant porogen comprises at least one of fluorocarbon, perfluorocarbon, amine cationic fluorocarbon surfactants, or ammonium cationic fluorocarbon surfactants.

18. A method as in claim 15 wherein the percentage of the surfactant porogen is selected to achieve a porous layer having index of refraction between 1.09 and 1.38.

19. A method as in claim 15 wherein the temperature of the heating process is between room temperature and 200 C.

20. A method as in claim 15 wherein the porous layer comprises a graded index of refraction.
